(19) United States
(12) Patent Application Publication
(10) Pub. No.: US 2026/0004090 A1
(43) Pub. Date: Jan. 1, 2026

(54) DELIMITED MACHINE-ENABLED LANGUAGE TRANSLATION

(71) Applicant: Cabo Applications LLC, Blacksburg, VA (US)

(72) Inventors: Michael John Barry, Blacksburg, VA (US); Beena Jacob, Morganville, NJ (US)

(73) Assignee: Cabo Applications LLC, Blacksburg, VA (US)

(21) Appl. No.: 18/880,710

(22) PCT Filed: Jul. 5, 2023
(86) PCT No.: PCT/US2023/026924

§ 371 Date: Jan. 2, 2025

Related U.S. Application Data
(60) Provisional application No. 63/358,642, filed on Jul. 6, 2022.

(51) Int. Cl. G06F 40/58; G06F 40/117

(52) U.S. Cl. CPC G06F 40/58; G06F 40/117

(57) ABSTRACT

In messaging applications wherein messages transmitted by a user are translated into the language of a message recipient, the informational integrity of message content can be preserved by delimiting selected terms within a message (for example, the names of people and places, and technical and trade terminology, which are easily mistranslated by common translation algorithms). The application may then maintain the originally-entered content of the delimited terms, while translating the terms that are not delimited. The translated message may then be displayed to the recipient, but with the delimited terms shown with their originally-entered content (but preferably with formatting different from that of the terms that were not delimited).

### FIELD OF THE INVENTION

This document concerns an invention relating generally to machine-enabled translation of human-language messages, and more specifically to remediation of errors/artifacts in machine translations.

### BACKGROUND OF THE INVENTION

Language translation applications exist wherein input statements are translated to output statements in other languages, with an example being described in International Patent Appl'n. Publ'n. WO2022/006034A1 (“Multilingual Conversation Tool”). Such translation applications often use text input, but may also or alternatively accept voice input, with the voice input typically being converted to text input via voice-to-text conversion. The text input statement is then processed by translation algorithms to convert it into a text output statement in another language, which may be converted into a voice output statement. The translation algorithms typically compensate for word ordering (e.g., the order in which subjects, verbs, and objects are presented in the input and output languages), and also seek to compensate for context, idiomatic expressions, multiple word meanings, and other challenges (e.g., possible grammar or spelling errors in input statements), in an attempt to provide output statements which (presumably) better reflect the input provider's intended meaning. However, these compensatory processes can themselves introduce mistranslation problems, particularly where input statements include extrinsic terms: terms which are outside the standard vocabulary of the language of the input statement, or which are within such vocabulary but have non-dictionary significance. Such extrinsic terms often arise with given (first) names, surnames, place names, brand names, and/or technical/trade terminology. When extrinsic terms exist in an input statement, the compensatory processes of the translation algorithms may assume that such extrinsic terms are mis-entered common terms. As an example, where a language translation application is used to communicate between two users, the first user might enter the Spanish-language message:
cuál es tu primer nombre
   with the second user receiving the English-language translation “what is your first name.” If the second user then responds with her first name:
Beena
   the application may assume this extrinsic term to be a mis-entry of the English phrase “been a,” and deliver to the first user the Spanish equivalent of
Sido una
   rather than delivering the intended name “Beena.” Such mistranslation can pose severe problems where users wish to communicate extrinsic terms, particularly in the event of emergencies where the accuracy of information (e.g., the names of places or medicines) may be critical.

### SUMMARY OF THE INVENTION

The invention, which is defined by the claims set forth at the end of this document, seeks to avoid mistranslation of extrinsic terms, and thereby maintain the informational integrity of content to be translated into another language. A basic understanding of features of exemplary versions of the invention can be attained from a review of the following brief summary of the invention, with more details being provided elsewhere in this document. To assist in the reader's understanding, the following review makes reference to the accompanying drawings (which are briefly reviewed in the “Brief Description of the Drawings” section following this Summary section of this document).

The invention can be incorporated into translation applications, and is particularly useful in multilingual messaging applications which translate user messages into different languages for delivery to recipients (such as the application described in the aforementioned WO2022/006034A1). In the invention, when the user wishes to communicate a user message to a recipient (with the user message being generated in the user's language, to be received by the recipient in the recipient's language), the user enters the user message on the user's computing device (e.g., a smartphone or personal computer). See 100 in FIG. 1. At 102, the user also enters a delimiter which defines a delimited portion 104 of the user message (in particular, any extrinsic term(s) within the user message), with the remaining portion of the user message then being an undelimited portion 106. The delimiter could be entered, for example, by swiping (e.g., running a finger or cursor) specifically over the extrinsic term(s);

by tapping each of the extrinsic term(s); and/or by entering a character prior to and/or after the extrinsic term(s) (with such character(s) preferably being a non-alphanumeric character, and more particularly a special character or other character not typically used in messaging, such as a caret or uncommon emoji). Where the user enters the user message via voice input, the user might enter the delimiter(s) by, for example, saying “delimiter” prior to and/or after speaking the extrinsic term(s), by tapping the smartphone prior to and/or after speaking the extrinsic term(s), and/or by tilting, flicking, or otherwise moving the smartphone prior to and/or after speaking the extrinsic term(s), with these inputs being interpreted as command to insert a delimiter in the user message. While the delimited portion of the user message is preferably defined by the user's entry of delimiters immediately prior to, and also immediately following, any extrinsic term(s) in the user message, a single delimiter might be entered to define the delimited portion. Thus, entry of a delimiter might be interpreted as designating any following alphanumeric string in the user message as the delimited portion, or conversely as designating any preceding alphanumeric string in the user message as the delimited portion.

At 108, the messaging application then translates the undelimited portion into the recipient's language to produce a translated undelimited portion, while the delimited portion is given no or limited translation. The messaging application then generates a translated user message 110 including the translated undelimited portion and the delimited portion, and transmits the translated user message for display on a computing device of the recipient. Thus, where the delimited portion is left untranslated, the recipient receives the user message in the recipient's language save for the extrinsic term(s), which are left with their originally-entered content.

The delimited portion might instead be given limited translation prior to inclusion in the translated user message 110, for example, the messaging application's translation algorithms might attempt translation without applying any spelling and/or grammar correction. In this case, if the translation algorithms cannot find an equivalent in the recipient's language for the text in the delimited portion, the delimited portion(s) of the translated user message might be presented to the recipient in the form in which the user entered them (as in FIG. 1).

Another example of limited translation, shown in FIG. 2, generally follows the steps of FIG. 1, but the delimited portion is translated into the recipient's language at 200 to generate a translated delimited portion, and this translated delimited portion is then translated back into the user's language at 202 (preferably by use of a translation algorithm different from the one used to generate the translated delimited portion at 200) to generate a back-translated delimited portion in the user's language. If the back-translated delimited portion is then not the same as the delimited portion as entered by the user as shown at 204, the delimited portion can be presented to the recipient within the translated user message in untranslated form (i.e., in the form in which it was entered by the user) at 206. If the back-translated delimited portion is instead the same as the delimited portion as entered by the user, the translated user message can be presented to the recipient with the translated delimited portion presented in place of the delimited portion (at 208). Regardless of how limited translation is performed, when the translated user message is displayed on the recipient's computing device, it can be useful to present the delimited portion therein in both the form entered by the user and in translated form (e.g., by presenting these side-by-side in succession).

When the translated user message is displayed on the computing device of the recipient, the undelimited portion, the delimited portion, and the translated undelimited portion (if any) are preferably displayed in different formats, e.g., in text of different colors, fonts, styles (such as italicized, bolded, underlined, etc.), capitalization, and/or otherwise having different appearance (including enclosing text in parentheses/brackets, quotes, or other characters that bound the portions).

Further potential advantages, features, and objectives of the invention will be apparent from the remainder of this document in conjunction with the associated drawings.

### BRIEF DESCRIPTION OF THE DRAWINGS

FIG. 1 is a diagram of an exemplary method of the invention wherein delimited terms are preserved without translation in the translated user message.

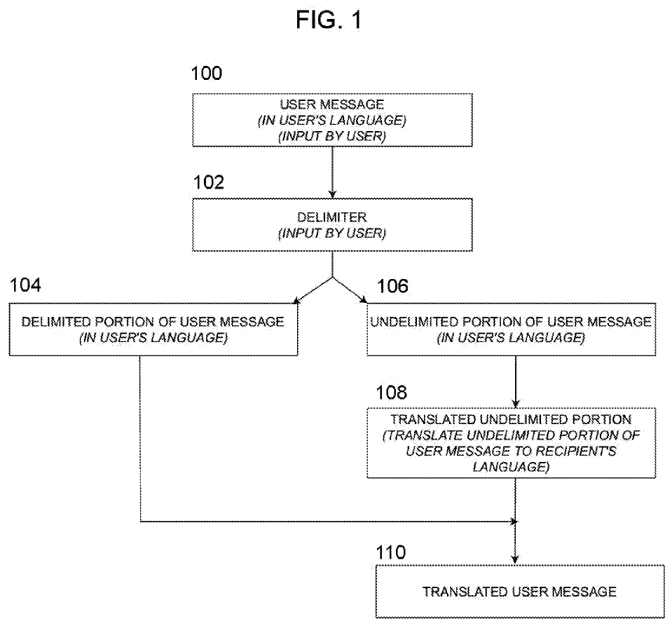

FIG. 2 is a diagram of an exemplary method of the invention wherein delimited terms undergo limited translation before inclusion in the translated user message.

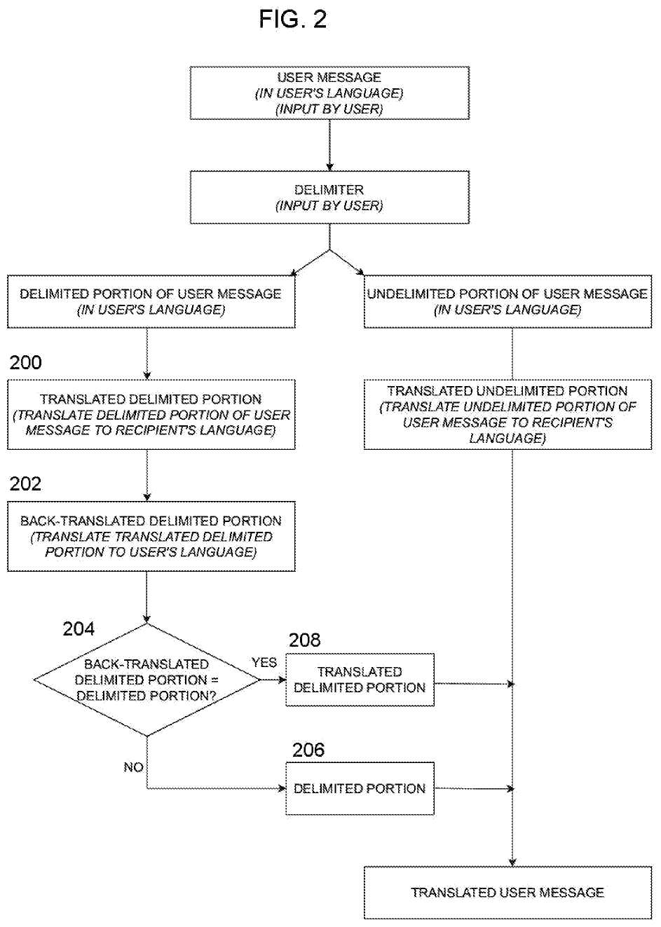

### DETAILED DESCRIPTION OF EXEMPLARY VERSIONS OF THE INVENTION

In the invention, a translation application—such as the message translation application described in International Patent Appl'n. Publ'n. WO2022/006034A1 (“Multilingual Conversation Tool”)—allows a user to place delimiters prior to and/or following any extrinsic terms within an input user message that are not to be translated, or which are subject to special translation rules (e.g., that translation should be performed under the assumption that no spelling/grammar correction should be applied to the delimited extrinsic terms). Thus, while conventional translation might be applied to the non-delimited terms within the message, no or partial translation might be applied to the delimited terms, with the output displaying the delimited terms without translation, or following application of special translation rules to the delimited terms. Thus, for example, when a user enters a text input statement, the user might insert a delimiter prior to and following any terms which are to be preserved without translation. A delimiter might consist of one or more typographic characters, since characters (and their meaning) may vary significantly between languages (e.g., between Roman/Latin, Hanzi, and Cyrillic characters). However, it is preferred that a unique icon/pictogram, emoji, or other rarely used character be used as a delimiter, with such character being one readily accessible via most standard keyboard/touchscreen user interfaces, or being one specially provided by a unique key/button in the translation application in question. Thus, using [symbol] as an exemplary delimiter, in the example above the user might enter:
[symbol] Beena [symbol]
   The translation application will then ignore (will not translate) the delimited “Beena” and deliver it to the recipient in the same form that it was input by the user.

Alternatively, the delimited text may be subjected to limited translation, wherein the delimited text is subjected to translation or other processing algorithms which are different from those applied to the non-delimited text. As a first example, text between the delimiters might be left untranslated unless the input text is equivalent to its back translation. (Back translation, as discussed in WO2022/006034A1, involves applying a first translation algorithm to input text in a first language to generate translated text in a second language, and then applying a second translation algorithm—preferably one different from the first translation algorithm—to convert the translated text to back-translated text in the first language, with inconsistencies between the original input text and the back-translated text being indicative of potential mistranslation.) Using the example above, the invention may apply spelling/grammar correction and translate “Beena” to Spanish as “sido una,” whereas “sido una” back-translated to English would be “been a.” Since the original text (“Beena”) and back-translated text (“Been a”) do not match, the input text “Beena” would be sent to the recipient without translation. As a second example, the translation application may apply no spelling or grammar correction to the delimited text, and the translation engine might simply transmit unresolvable (untranslatable) text without alteration. Using the example above, since the input text “Beena” has no Spanish-language equivalent, it would simply be transmitted to the recipient without alteration. As another example, a recipient might receive the following message from a user (which was entered by the user in French and translated to the recipient's English):
Can you recommend a medicine for migraines?
   The second user might then enter:
For chronic migraine you can try [symbol] OnabotulinumtoxinA [symbol]
   The translation application will then apply no (or limited) translation of the delimited “OnabotulinumtoxinA,” returning to the first user the French translation of:
Pour la migraine chronique vous pouvez essayer OnabotulinumtoxinA
   If the first user specified Hindi as his/her language rather than French, the response might be received by the first user as:
[symbol] [symbol] OnabotulinumtoxinA

Delimiters need not be visible to a user entering a user message containing one or more delimited terms, nor do they need be visible to a recipient receiving the translated user message. However, it is preferred that entered user messages be displayed to users, and that translated user messages be displayed to recipients, with the delimiters visible, and/or that the delimited term(s) be displayed with a different appearance (e.g., italicized or otherwise in a different style, font, and/or color), to indicate that no or limited translation will be or was applied to the delimited terms. To illustrate, the invention might display the foregoing message to the recipient as:
[symbol] [symbol] [symbol] OnabotulinumtoxinA

[symbol]

The translation application might also or alternatively display the delimited term(s) with an attempted translation of the delimited term(s), with the attempted translation being bracketed or otherwise specially displayed to indicate to the recipient that it may be subject to translation errors
[symbol] [symbol] [symbol] OnabotulinumtoxinA

[symbol]

[symbol]

Rather than the translation application providing a special/nonstandard character as a delimiter, the translation application might simply regard any nonstandard character entered by a user, or any nonstandard character chosen from some subset of uncommonly used nonstandard characters (e.g., any emoji save for commonly-used “happy face,” “sad face,” “angry face,” and “surprised face” emojis), as being a delimiter. As another example, a translation application might allow users to “highlight” terms—as by swiping over selected terms, or tapping twice in rapid succession on one or more selected terms on a touchscreen display—with delimiters then being placed prior to and after the selected terms.

Different delimiters might be used for different matter. For example, a user might delimit the names of places with one type of delimiter; the names of persons with another type of delimiter; and the names of other things with yet another type of delimiter. In this case, the delimited matter, sent to the recipient with no or limited translation, might be displayed with its corresponding delimiter, or otherwise be differently displayed to the recipient in dependence on its matter: a place name might be in one style, font, and/or color, a person name might be in another style, font, and/or color, and the names of other things might be in yet another style, font, and/or color. In this manner, the recipient might better understand the content/context of the delimited matter.

To guard against unbalanced delimiters (i.e., a user neglecting to provide a “stop” delimiter after one or more terms following a “start” delimiter), it is preferred that the translation application regard a “stop” delimiter as being placed after the first term following a “start” delimiter unless a user places a “stop” delimiter after some following term.

Delimiters can also be entered by a user where the translation application accepts voice inputs. Here a user might speak his/her message, pause prior to speaking any terms that are not to be translated, enter a start delimiter, speak the term(s) to be left untranslated or having limited translation, and then enter a stop delimiter. The delimiters can be entered via touch input as discussed above, or could take other or additional forms (e.g., via motion input such as a quick flick or tilt of a smartphone on which the translation application is running). When a voice-to-text algorithm converts the voice message to text for translation, the delimiters indicate that the delimited matter should not be translated or should be subject to limited translation. The voice-to-text algorithm might then convert the spoken delimited matter to a phonetic equivalent, without attempting to convert the delimited matter to a known term. If voice output is delivered to the recipient, the delimited matter might be delivered to the recipient in its originally-entered form (i.e., the delimited matter might be delivered to the recipient exactly as captured from the entrant, in the entrant's voice).

The invention may be provided in the form of software or other machine-readable instructions which configure a general-purpose computer (e.g., a conventional personal computer, smartphone, microcontroller, or the like), a special-purpose computer (e.g., an Application Specific Integrated Circuit (ASIC)), or multiple connected computers of either or both types to implement the desired functionality, with the instructions being permanently or temporarily encoded on a non-transitory machine-readable medium such as a chip, disc, tape, or other medium. The invention may also or alternatively be embodied in whole or in part within the circuitry of a programmed or programmable device.

The versions of the invention described above are merely exemplary, and the invention is not intended to be limited to these versions. Rather, the scope of rights to the invention is limited only by the claims set out below, and the invention encompasses all different versions that fall literally or equivalently within the scope of these claims.

What is claimed is:

1. A method for maintaining the integrity of content within a user message to be delivered by a user to a recipient, wherein:
A. the recipient's language differs from the user's language, and
B. the user message is in the user's language and is to be delivered to the recipient in the recipient's language,
the method including the steps of:
a. accepting user input of:
(1) a user message, and
(2) a delimiter defining a delimited portion of the user message, on a computing device of a user, wherein the delimited portion and an undelimited portion together define the user message,
c. translating the delimited portion into the recipient's language, thereby generating a translated delimited portion,
d. translating the translated delimited portion into a back-translated delimited portion in the user's language,
e. displaying a translated user message on a computing device of the recipient wherein:
(1) where the delimited portion and back-translated delimited portion are the same, the translated user message includes:
(a) the translated undelimited portion, and
(b) the translated delimited portion.
(2) where the delimited portion and back-translated delimited portion differ, the translated user message includes:
(a) the translated undelimited portion, and
(b) the delimited portion.

2. The method of claim 1 wherein the translated user message is displayed on the computing device of the recipient with the delimited portion formatted differently than the translated undelimited portion where the delimited portion and back-translated delimited portion differ.

3. The method of claim 1 wherein the displayed translated user message further includes the delimited portion, with the delimited portion formatted differently than the translated delimited portion.

4. The method of claim 1 wherein the delimited portion and the undelimited portion are displayed on the user's computing device with the delimited portion formatted differently than the undelimited portion.

5. The method of claim 1 wherein the delimited portion of the user message is defined by an alphabetic string input by the user immediately following user input of the delimiter.

6. The method of claim 1 wherein the delimiter is defined by user input of one or more of:
a. a nonalphanumeric character,
b. tapping the computing device of the user, and
c. moving the computing device of the user, prior to and following user input of the delimited portion of the user message.

7. The method of claim 1 wherein:
a. the user message is displayed on the user's computing device, and
b. the delimiter is input by the user by swiping across at least a portion of the displayed user message.

8. A method for maintaining the integrity of content within a user message to be delivered by a user to a recipient, wherein:
A. the recipient's language differs from the user's language, and
B. the user message is in the user's language and is to be delivered to the recipient in the recipient's language,
the method including the steps of:
a. accepting user input of:
(1) a user message, and
(2) a delimiter defining a delimited portion of the user message, on a computing device of a user, wherein the delimited portion and an undelimited portion together define the user message,
c. translating the undelimited portion into the recipient's language, thereby generating a translated undelimited portion,
d. displaying a translated user message on a computing device of the recipient, the translated user message including:
(1) the translated undelimited portion, and
(2) the delimited portion.

9. The method of claim 8 wherein the translated user message is displayed on the computing device of the recipient with the delimited portion formatted differently than the translated undelimited portion.

10. The method of claim 8 wherein the delimited portion and the undelimited portion are displayed on the user's computing device with the delimited portion formatted differently than the undelimited portion.

11. The method of claim 8:
a. further including the step of translating the delimited portion into the recipient's language, thereby generating a translated delimited portion, and
b. wherein the displayed translated user message further includes the translated delimited portion.

12. The method of claim 8 wherein the delimited portion of the user message is defined by an alphabetic string input by the user immediately following user input of the delimiter.

13. The method of claim 8 wherein the delimiter is defined by user input of one or more of:
a. a nonalphanumeric character,
b. tapping the computing device of the user, and
c. moving the computing device of the user, prior to and following user input of the delimited portion of the user message.

14. The method of claim 8 wherein:
a. the user message is displayed on the user's computing device, and
b. the delimiter is input by the user by swiping across at least a portion of the displayed user message.

15. A method for maintaining the integrity of content within a user message to be delivered by a user to a recipient, wherein:
A. the recipient's language differs from the user's language, and
B. the user message is in the user's language and is to be delivered to the recipient in the recipient's language,
the method including the steps of:
a. accepting user input of the user message on a computing device of the user,
b. accepting user input of a delimiter on the user's computing device, wherein the delimiter specifies a delimited portion of the user message, whereby the user message then consists of the delimited portion and an undelimited portion,
c. generating a translated user message including:
(1) the delimited portion, and
(2) the undelimited portion translated into the recipient's language,
d. transmitting the translated user message to a computing device of the recipient for display.

16. The method of claim 15 wherein the translated user message is displayed on the computing device of the recipient with the delimited portion formatted differently than the translated undelimited portion.

17. The method of claim 15 wherein:
a. the translated user message further includes the delimited portion translated into the recipient's language, and
b. the translated user message is displayed on the computing device of the recipient with the delimited portion formatted differently than the delimited portion translated into the recipient's language.

18. The method of claim 15 wherein the delimited portion and the undelimited portion are displayed on the user's computing device with the delimited portion formatted differently than the undelimited portion.

19. The method of claim 15 wherein the delimited portion of the user message is defined by an alphabetic string input by the user immediately following user input of the delimiter.

20. The method of claim 15 wherein the delimiter is defined by user input of one or more of:
a. a nonalphanumeric character,
b. tapping the computing device of the user, and
c. moving the computing device of the user,
prior to and following user input of the delimited portion of the user message.
